(19) United States
(12) Patent Application Publication
(10) Pub. No.: US 2010/0245160 A1
(43) Pub. Date: Sep. 30, 2010

(54) FMCW SIGNAL GENERATION CIRCUIT

(75) Inventors: Hiroki Sakurai, Fuchu-shi (JP); Hiroaki Ishihara, Kawasaki-shi (JP); Toshiya Mitomo, Kawasaki-shi (JP)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Kabushiki Kaisha Toshiba

(21) Appl. No.: 12/557,853

(22) Filed: Sep. 11, 2009

(30) Foreign Application Priority Data
Mar. 31, 2009 (JP) P2009-087992

(51) Int. Cl. G01S 13/00

(52) U.S. Cl. 342/200

(57) ABSTRACT

An FMCW signal generation circuit includes: an oscillator configured to oscillate in an oscillation frequency that is variable in accordance with a control signal being input thereto and output an FMCW signal having the oscillation frequency; a phase detector configured to detect a phase of the FMCW signal; a first differentiator configured to obtain a frequency by differentiating the phase detected by the phase detector; a second differentiator configured to obtain a frequency variation rate by differentiating the frequency obtained by the first differentiator; a subtractor configured to calculate an error between a set frequency variation rate that is set at a given value and the frequency variation rate obtained by the second differentiator; and an integrator configured to generate the control signal for controlling the oscillation frequency of the oscillator by integrating the error calculated by the subtractor.

### CROSS-REFERENCE TO THE RELATED APPLICATION(S)

The present disclosure relates to the subject matters contained in Japanese Patent Application No. 2009-087992 filed on Mar. 31, 2009, which are incorporated herein by reference in its entirety.

### FIELD

The present invention relates to an FMCW signal generation circuit suitable to be used in a radar apparatus.

### BACKGROUND

Among radar apparatus using a radio signal are ones using an FMCW (frequency modulated continuous wave) signal. Radar apparatus using an FMCW signal detects a distance to an object, a speed relative to an object, or the like utilizing the fact that the frequency of an output signal of a multiplier which multiplies a reception signal that is a reflection signal from the object of an FMCW signal sent from a radar transmitter by a transmission signal being sent at the instant of reception of the reception signal is determined by a time difference between the two signals. FMCW signals used in radars are required that their frequency varies approximately linearly with respect to time.

In general, an FMCW signal generation circuit providing such a frequency variation is realized by a direct digital synthesizer (DDS) including a digital signal processor for providing a frequency through digital signal processing and a DA converter (DAC) for converting a resulting digital signal into an analog signal. Among methods for generating an FMCW signal in a frequency band that is actually used in a radar are a first method of mixing an output signal of a DDS with a signal having a carrier frequency and a second method using a PLL circuit which employs an output signal of a DDS as a phase reference signal and includes a frequency divider in the loop.

An example of the first method is disclosed in the related-art document 1, and an example of the second method is disclosed in the related-art document 2, which are listed below.

Related-Art Document 1: S. Plata, “FMCW Radar Transmitter Based on DDS Synthesis,” International Conference on Microwaves, Radar & Wireless Communications, 2006

Related-Art Document 2: A. Stelzer et al., “Fast 77 GHz Chirp with Direct Digital Synthesis and Phase Locked Loop,” Asia-Pacific Microwave Conference 2005 In general, in FMCW radar apparatus, the FM modulation width of an FMCW signal is required to be greater than hundreds of megahertz. To realize such a large FM modulation width by the method disclosed in the related-art document 1, the DDS should operate at a very high clock frequency. That is, the DDS should have an extremely high operation frequency.

Where a PLL circuit including a frequency divider (division ratio: N) in the loop is used as in the related-art document 2, the frequency of a reference signal which is an output signal of the DDS can be made 1/N of the frequency of an FMCW signal. Therefore, the operation frequency of the DDS can be made much lower than in the method of the related-art document 1. However, it the short-range resolution of a radar apparatus using an FMCW signal is set at about 0.5 m, it is necessary to cause a frequency variation in the FMCW signal in a time interval in which radio waves travel a distance of 0.5 m×2. This time interval is about 3.3 ns. In this case, the DDS which is used in a circuit for generating a reference FMCW signal for the PLL circuit needs to operate at a sampling frequency of at least 600 MHz. Furthermore, where n-fold oversampling is performed in the DAC of the DDS to reduce quantization noise, it needs to operate at a very high sampling frequency of n×600 MHz.

As described above, in each of the FMCW signal generation circuits according to the conventional methods disclosed in related-art documents 1 and 2, the operation frequency of the DDS is very high. This makes it very difficult to realize an inexpensive one-chip radar transmission/reception IC which is manufactured by a CMOS process or low-power-consumption circuits.

### SUMMARY

According to a first aspect of the invention, there is provided an FMCW signal generation circuit including: an oscillator configured to oscillate in an oscillation frequency that is variable in accordance with a control signal being input thereto and output an FMCW signal having the oscillation frequency; a phase detector configured to detect a phase of the FMCW signal; a first differentiator configured to obtain a frequency by differentiating the phase detected by the phase detector; a second differentiator configured to obtain a frequency variation rate by differentiating the frequency obtained by the first differentiator; a subtractor configured to calculate an error between a set frequency variation rate that is set at a given value and the frequency variation rate obtained by the second differentiator; and an integrator configured to generate the control signal for controlling the oscillation frequency of the oscillator by integrating the error calculated by the subtractor.

According to a second aspect of the invention, there is provided an FMCW signal generation circuit including: an oscillator configured to oscillate in an oscillation frequency that is variable in accordance with a control signal being input thereto and output an FMCW signal having the oscillation frequency; a frequency divider configured to obtain a frequency division signal by frequency-dividing the FMCW signal generated by the oscillator; a digital phase detector configured to obtain a phase value by detecting a phase of the frequency division signal; a first differentiator configured to obtain a frequency by differentiating the phase value; a second differentiator configured to obtain a frequency variation rate by differentiating the frequency obtained by the first differentiator; a subtractor configured to calculate a difference between a set frequency variation rate that is set at a given value and the frequency variation rate; a DA converter configured to convert the difference calculated by the subtractor into an error signal having analog value; and an integrator configured to generate the control signal for the oscillator by integrating the error signal, werein the first differentiator, the second differentiator, and the subtractor are configured as digital circuits.

According to a third aspect of the invention, there is provided an FMCW signal generation circuit including: an oscillator configured to oscillate in an oscillation frequency that is variable in accordance with a control signal being input thereto and output an FMCW signal having the oscillation frequency; a frequency divider configured to frequency-divide the FMCW signal generated by the oscillator; a digital phase detector configured to obtain a phase value by detecting a phase of the FMCW signal being frequency-divided by the frequency divider; a first differentiator configured to obtain a frequency by differentiating the phase value; a second differentiator configured to obtain a frequency variation rate by differentiating the frequency; a comparator configured to compare and determine whether the frequency is higher than a first set frequency and whether the frequency is lower than a second set frequency that is lower than the first set frequency; a selector configured to select an absolute value of a second set frequency variation rate that is set at a negative value when the frequency is higher than the first set frequency and select a first set frequency variation rate that is set at a given positive value when the frequency is lower than the second set frequency; a subtractor configured to calculate an error that is a difference between the first set frequency variation rate or the absolute value of the second set frequency variation rate selected by the selector and an absolute value of the frequency variation rate; and an integrator comprising a fixed capacitor, a first DA converter, and a second DA converter, the integrator being configured to generate the control signal for the oscillator, wherein the second DA converter causes a current that is proportional to the error to flow out of the fixed capacitor when the frequency is higher than the first set frequency, and wherein the first DA converter causes a current that is proportional to the error to flow into the fixed capacitor when the frequency is lower than the second set frequency.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a block diagram of an FMCW signal generation circuit according to a first embodiment.

FIG. 2 is a transfer function diagram of the FMCW signal generation circuit according to the first embodiment.

FIG. 3 is a block diagram of an FMCW signal generation circuit according to a second embodiment.

FIG. 4 shows an operation procedure of the FMCW signal generation circuit according to the second embodiment.

FIG. 5 shows an FMCW signal that is generated by the FMCW signal generation circuit according to the second embodiment.

FIG. 6 is a block diagram of an FMCW signal generation circuit according to a third embodiment.

FIG. 7 shows an FMCW signal that is generated by the FMCW signal generation circuit according to the third embodiment.

FIG. 8 is a block diagram of an FMCW signal generation circuit according to a fourth embodiment.

FIG. 9 is a block diagram of an FMCW signal generation circuit according to a modification of the fourth embodiment.

FIG. 10 is a circuit diagram of an integrator of the FMCW signal generation circuit according to the fourth embodiment.

FIG. 11 is a block diagram of an FMCW signal generation circuit according to a fifth embodiment.

FIG. 12 is a block diagram of an FMCW signal generation circuit according to a sixth embodiment,

FIG. 13 shows an FMCW signal that is generated by the FMCW signal generation circuit according to the sixth embodiment.

FIG. 14 is a block diagram of an FMCW signal generation circuit according to a seventh embodiment.

FIG. 15 shows a voltage/digital-controlled oscillator of the FMCW signal generation circuit according to the seventh embodiment.

FIG. 16 is a block diagram of a radar apparatus according to an eighth embodiment.

FIG. 17 is a block diagram of an FMCW signal generation circuit according to another modification of the fourth embodiment.

FIG. 18 is a block diagram of an FMCW signal generation circuit according to a modification of the sixth embodiment.

### DETAILED DESCRIPTION OF THE EMBODIMENTS

Hereinafter, embodiments of the invention will be described with reference to the drawings. In the following description, the same or similar components will be denoted by the same reference numerals, and the duplicate description thereof will be omitted.

### First Embodiment

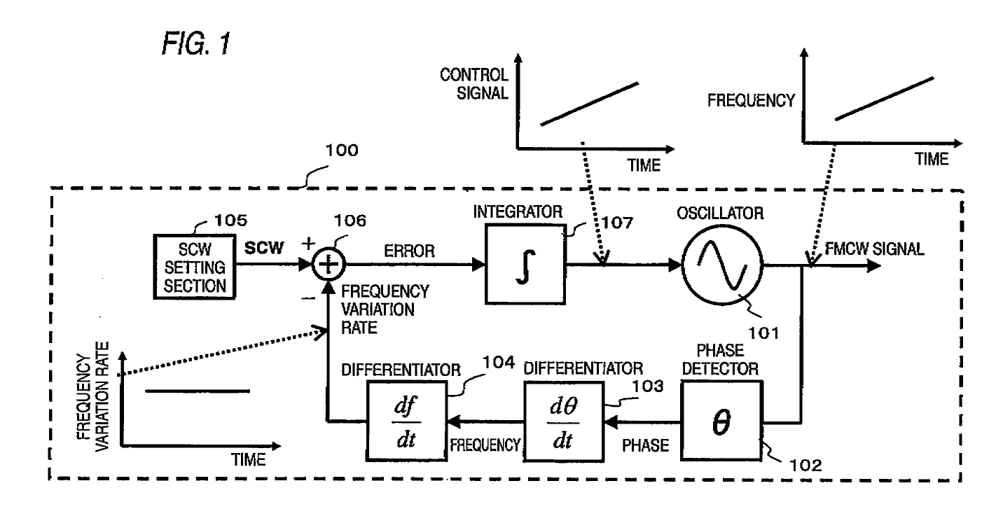

FIG. 1 is a block diagram of an FMCW signal generation circuit 100 according to a first embodiment.

The FMCW signal generation circuit 100 is equipped with an oscillator 101 for generating an FMCW signal whose frequency varies according to a control signal, a phase detector 102 for detecting a phase of the FMCW signal, a first differentiator 103 for converting the detected phase into a frequency through differentiation, and a second differentiator 104 for converting the resulting frequency into a frequency variation rate through differentiation. The FMCW signal generation circuit 100 is also equipped with an SCW setting section 105 for generating a desired frequency variation rate SCW (set at a fixed value), a subtractor 106 for calculating, as an error, a difference between the SCW and the frequency variation rate that is output from the second differentiator 104, and an integrator 107 for integrating the error and outputs a result as a control signal for the oscillator 101. The oscillator 101 generates an FMCW signal whose frequency varies according to the control signal that is output from the integrator 107.

The operation of the FMCW signal generation circuit 100 according to the embodiment will be described below. An FMCW signal that is output from the FMCW signal generation circuit 100 is such that its frequency varies approximately linearly with respect to time.

A description will be made of an example case in which the FMCW signal generation circuit 100 generates an FMCW signal whose frequency varies at the constant rate SCW with respect to time. The phase detector 102 detects a phase of the FMCW signal. The phase is differentiated two times by the first differentiator 103 and the second differentiator 104, and a frequency variation rate A is output from the second differentiator 104. The subtractor 106 obtains an error (SWC-A) by subtracting the frequency variation rate A from the SCW that is output from the SCW setting section 105. For example, if the frequency variation rate A is smaller than the SCW, the error is large and a variation rate of a control signal for the oscillator 101 that is obtained by integrating the error with the integrator 107 is also large. As a result, a variation rate of the oscillation frequency which varies according to the control signal is also large. That iSr the frequency variation rate A increases so as to approach the SCW. Therefore, the variation rate of the oscillation frequency is controlled so as to become equal to the constant value SCW as the above operation is performed repeatedly.

As described above, the FMCW signal generation circuit 100 according to the embodiment can cause the frequency of an FMCW signal that is output from the oscillator 101 to vary approximately linearly by negatively feeding back the frequency variation rate.

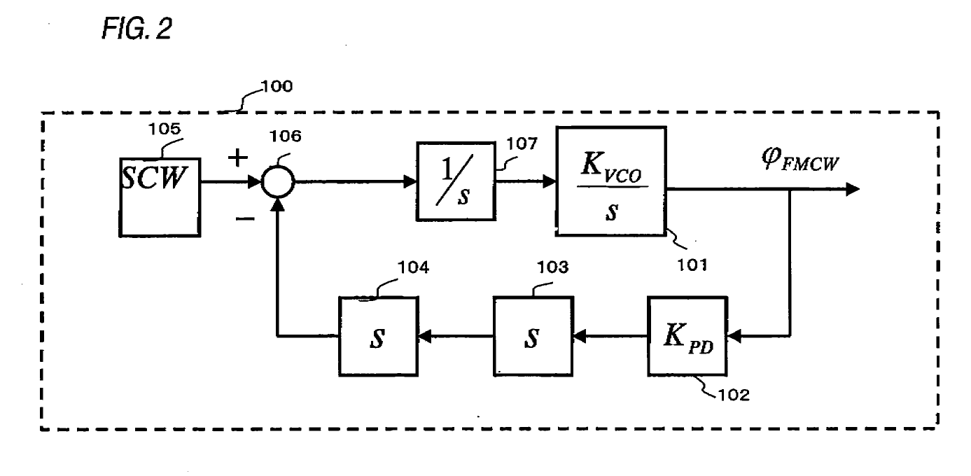

FIG. 2 is a transfer function diagram of the FMCW signal generation circuit 100 according to the embodiment. The symbol φ_{FMCW} represents the phase of an output signal (FMCW signal) of the oscillator 101 and K_{PD} represents the detection gain of the phase detector 102. According to the Laplace transform, the differentiation and the integration are represented by s and 1/s, respectively. Since the oscillator 101 has an integration effect, its transfer function is represented by K_{VCO}/s. Symbol SCW represents the set frequency variation rate that is set by the SCW setting section 105 and has a constant value.

As seen from FIG. 2, the transfer characteristic of the FMCW signal generation circuit 100 according to the embodiment is given as following equations (1) and (2).

$$\begin{matrix}( S C W - {K}_{PD} {s}^{2} {ϕ}_{FMCW} ) {K}_{VCO} / {s}^{2} = {ϕ}_{FMCW} & ( 1 ) \\ ℒ [ \frac{{d}^{2} {ϕ}_{FMCW}}{d {t}^{2}} ] = {s}^{2} {ϕ}_{FMCW} = \frac{{K}_{VCO}}{1 + {K}_{PD} {K}_{VCO}} S C W & ( 2 )\end{matrix}$$

Assuming K_{VCO}>>1, the transfer characteristic is given by the following equation (3).

$$ℒ [ \frac{{d}^{2} {ϕ}_{FMCW}}{d {t}^{2}} ] = {s}^{2} {ϕ}_{FMCW} = \frac{{K}_{VCO}}{1 + {K}_{PD} {K}_{VCO}} S C W ≅ \frac{S C W}{{K}_{PD}} \qquad ( 3 )$$

If K_{PD} is equal to 1 in equation (3), the frequency variation rate of the output signal (FMCW signal) coincides with SCW without depending on the nonlinearity of the gain KVCO of the oscillator 101 or any other parameters.

Therefore, the frequency of the FMCW signal can be varied linearly with respect to time by making SCW constant with respect to time.

It is therefore concluded that the FMCW signal generation circuit 100 according to the embodiment can generate an FMCW signal whose frequency varies with a high degree of linearity. Furthermore, unlike in the prior art, the FMCW signal generation circuit 100 according to the embodiment does not require a DDS whose operation frequency is very high. The differentiators 103 and 104 and the subtractor 106 which are components of the FMCW signal generation circuit 100 according to the embodiment can be implemented as simple circuits. Therefore, the FMCW signal generation circuit 100 according to the embodiment can be implemented with a small circuit scale and a low power consumption. The FMCW signal generation circuit 100 according to the embodiment can be such as to be suitable for integration by a CMOS process.

### Second Embodiment

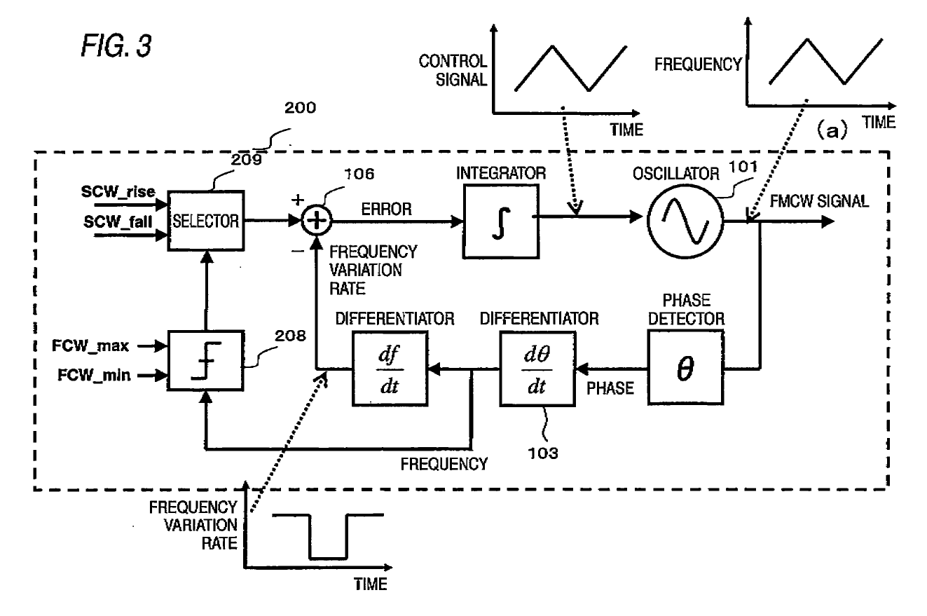

FIG. 3 is a block diagram of an FMCW signal generation circuit 200 according to a second embodiment. As shown in graph (a) shown in FIG. 3, the FMCW signal generation circuit 200 according to this embodiment can generate an FMCW signal whose frequency varies in a triangular-wave form.

The FMCW signal generation circuit 200 according to the embodiment is different from the FMCW signal generation circuit 100 according to the first embodiment in that a comparator 208 and a selector 209 are added.

A first set frequency FCW_max representing a maximum frequency and a second set frequency FCW_min representing a minimum frequency are set in the comparator 208. The comparator 208 compares the magnitudes of an output frequency of the first differentiator 103 and FCW_max or compares the magnitudes of an output frequency of the first differentiator 103 and FCW_min, and outputs a comparison result.

The selector 209 selects one of a first set frequency variation rate SCW_rise and a second set frequency variation rate SCW_fall according to the comparison result of the comparator 208, and outputs the selected set frequency variation rate to the subtractor 106. Symbol SCW_rise represents a set frequency variation rate corresponding to a case that the frequency increases, and has a positive value. Symbol SCW_fall represents a set frequency variation rate corresponding to a case that the frequency decreases, and has a negative value.

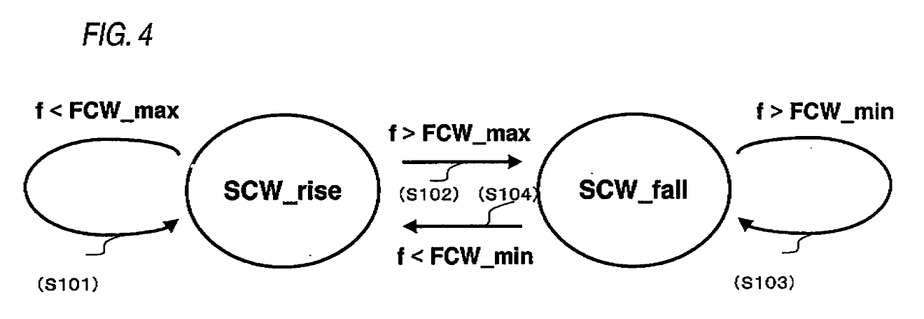

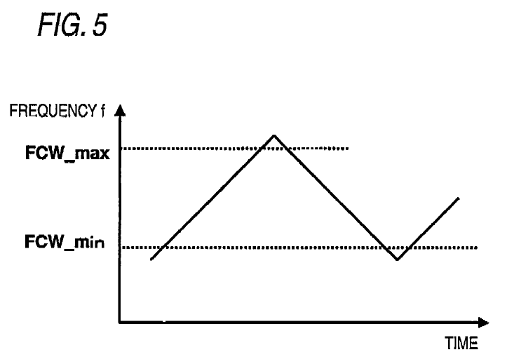

FIG. 4 shows an operation procedure of the FMCW signal generation circuit 200 according to the embodiment. FIG. 5 shows an FMCW signal that is output from the FMCW signal generation circuit 200 according to the embodiment.

First, assume that the selector 209 is selecting the set frequency variation rate SCW rise and outputting it to the subtractor 106. The oscillator 101 operates so that the frequency variation rate of the FMCW signal coincides with SCW_rise. Therefore, the oscillation frequency increases linearly with time. The selector 209 continues to select SCW_rise as long as the oscillation frequency is lower than FCW_max (S101). On the other hand, if the oscillation frequency becomes higher than FCW_max, the comparator 208 switches the comparison result and the selector 209 selects SCW_tall and outputs it to the subtracter 106 (S102). Since the second set frequency variation rate SCW_fall has a negative value, the oscillation frequency decreases linearly with time. The selector 209 continues to select SCW_fall as long as the oscillation frequency is higher than FCW min (S103). If the oscillation frequency becomes lower than FCW_min, the comparator 208 switches the comparison result and the selector 209 again selects SCW_rise and outputs it to the subtractor 106 (S104).

As shown in FIG. 5, an FMCW signal whose frequency varies in a triangular-wave form can be obtained. As seen from FIG. 5, a triangular wave (which represents a frequency variation) having an arbitrary slope and amplitude can be obtained by changing FCW_max, FCW_min, SCW_rise, and SCW_fall.

The comparator 208 and the selector 209 of the FMCW signal generation circuit 200 according to the embodiment can both be implemented as a simple circuit.

It is therefore concluded that the FMCW signal generation circuit 200 according to the embodiment can not only provide the same advantages as the FMCW signal generation circuit 100 according to the first embodiment does but also generate an FMCW signal whose frequency varies in a triangular-wave form with a high degree of linearity. Although the FMCW signal generation circuit 200 according to the embodiment employs two set frequencies FCW and two set frequency variation rates SCW, the oscillation frequency of the oscillator 101 can be varied in any of various waveforms other than a triangular wave, such as a trapezoidal wave, by changing the number of set frequencies FCW and the number of set frequency variation rates SCW.

### Third Embodiment

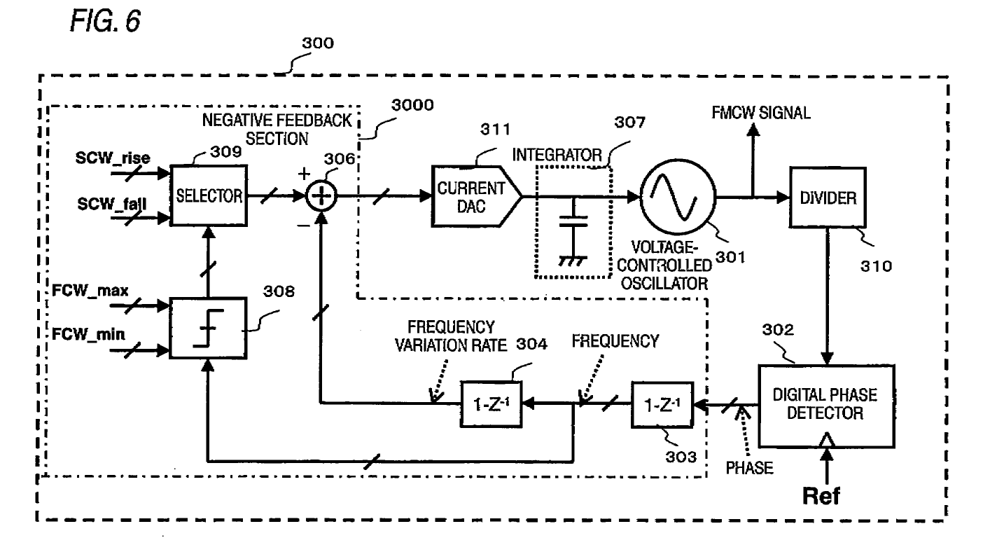

FIG. 6 shows an FMCW signal generation circuit 300 according to a third embodiment. The FMCW signal generation circuit 300 according to the third embodiment, which is equivalent to the FMCW signal generation circuit 200 according to the second embodiment, is configured by using digital circuits and analog circuits.

The FMCW signal generation circuit 300 according to this embodiment is composed of a voltage-controlled oscillator (VCO) 301, a frequency divider 310, a digital phase detector 302, a negative feedback section 3000 (first differentiator 303, second differentiator 304, comparator 308, selector 309, and subtractor 306) which is implemented as a digital circuit, a current digital-to-analogue converter (current DAC) 311, and an integrator 307 which is implemented by a fixed capacitor.

The frequency divider 310 divides the frequency of an FMCW signal that is output from the voltage-controlled oscillator 301. The FMCW signal has a very high frequency. On the other hand, the frequency of a signal whose phase can be detected by the digital phase detector 302 is lower than about several gigahertz. Therefore, it is difficult for the digital phase detector 302 to directly detect the phase of the FMCW signal. This is the reason why the frequency divider 310 is used. For example, in the case of a 77-GHZ-band millimeter-wave radar, the frequency divider 310 lowers the frequency to about 1.2 GHz through division by 64.

The digital phase detector 302 detects a phase of a received signal that has been produced by the frequency divider 310 through the frequency division. The digital phase detector 302 detects a phase of the received signal and outputs a digital code (digital phase value) in every cycle of a reference signal Ref. The digital phase detector 302 is implemented as a counter circuit which counts and outputs the number of pulses of a received signal or a time-to-digital converter (TDC) which detects a time difference between rising edges of a received signal and a reference signal and outputs a resulting digital value. Alternatively, such a counter circuit and time-to-digital converter may be combined together.

The negative feedback circuit 3000, which is implemented as a digital circuit, calculates an error from the digital phase value (digital code). The reference signal Ref or a signal obtained by re-sampling the reference signal Ref using the output signal of the frequency divider 310 is used as a clock signal that is necessary for the digital circuits. Implementing a differentiator as an analog circuit requires an amplifier, fixed capacitors, and fixed resistors. On the other hand, a digital circuit as a differentiator can be implemented by delaying an input signal by one clock and subtracting the delayed signal from the original signal. The comparator 308, the selector 309, and the subtractor 306 can easily be implemented as digital circuits. Therefore, the circuit scale and the power consumption of the FMCW signal generation circuit 300 can be reduced by implementing the first differentiator 303, the second difterentiator 309, the comparator 308, the selector 309, and the subtractor 306 as digital circuits.

The error (digital code) that is output from the subtractor 306 is converted into an analog current signal (analog error) by the current DAC 311. The analog current signal is integrated by the integrator (fixed capacitor) 307 and a resulting signal is used as a control voltage signal for the voltage-controlled oscillator 310.

If the error is a constant positive value, a constant current flows into the fixed capacitor and hence a control voltage signal that increases at a constant rate with time is obtained.

In a configuration in which the integrator 307 is implemented as a digital circuit, to control the oscillator (301), it would be necessary to convert an integrated digital code with a voltage-output digital analog converter into an analog control voltage for a voltage-controlled oscillator or to directly input an integrated digital code to a digitally controlled oscillator (DCO). However, the control signal for the oscillator (301) needs to vary approximately linearly with respect to time. To satisfy a specification for a radar and to suppress distortion, the DA converter or the digitally controlled oscillator should have a high operation speed and high accuracy.

On the other hand, where the integrator 307 is implemented as an analog circuit, it is sufficient for the current DAC 311 to output a current that is approximately constant with respect to time and hence it is allowed to have a low operation speed.

Therefore, the circuit scale and the power consumption of the FMCW signal generation circuit 300 can be reduced by implementing the integrator 307 as an analog circuit.

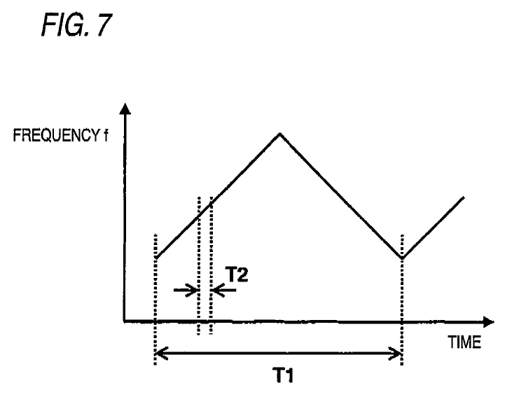

Consideration will be given to a case of generating, by using the FMCW signal generation circuit 300 according to the embodiment, an FMCW signal whose frequency varies like a triangular-wave having a first cycle T1 (see FIG. 7). The digital phase detector 302, the negative feedback section 3000, and the DA converter 311 operate at a cycle T2 of a reference signal Ref and perform a negative feedback control. To enable a normal negative feedback control, it is necessary that T2 be sufficiently smaller than TI. It T1 and T2 are 500 μs and 5 μs (i.e, 1/100 of T1), respectively, a negative feedback control is performed 100 times in the period of T1. In this case, the frequency of the reference signal Ref is 200 kHz, which is sufficiently lower than an operation frequency of hundreds of megahertz that is necessary in conventional DACs. Since the operation frequency of the DA converter 311 can thus be set low, the circuit scale and the power consumption of the FMCW signal generation circuit 300 according to the embodiment can be reduced accordingly.

The FMCW signal generation circuit 300 according to the embodiment can provide the same advantages as the FMCW signal generation circuits 100 and 200 according to the first and second embodiments do. In particular, since the first differentiates 303, the second differentiator 309, the comparator 308, the selector 309, and the subtractor 306 are implemented as digital circuits and the integrator 307 is implemented as a fixed capacitor, the FMCW signal generation circuit 300 according to the embodiment can be implemented so as to have a simple configuration.

The digital phase detector 302 and the DA converter 311 may operate at different cycles. For example, the accuracy of the DA converter 311 can be increased by causing it to perform oversampling operation. Furthermore, periodic components that may cause spurious emission can be reduced by using a ΣΔ DA converter.

The frequency of an FMCW signal may be shifted by a given value by using a mixer instead of the frequency divider 310. For example, a frequency shift up to about 1 GHz can be attained by multiplying a signal in a 77-GHz band by a 76-GHz signal with a mixer.

A voltage-output DA converter and a current-output transconductance amplifier may be used in place of the current DAC 311.

### Fourth Embodiment

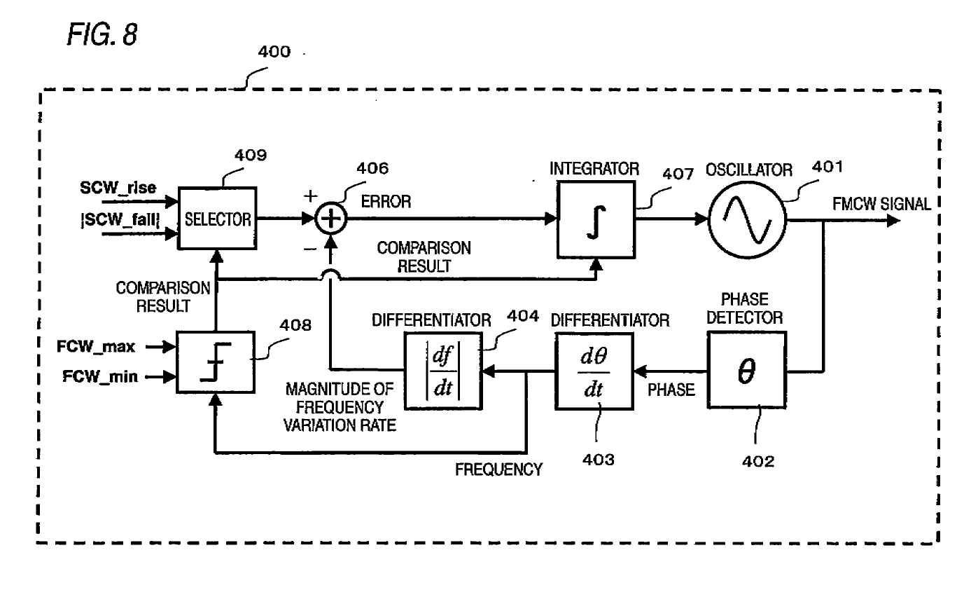

Next, a fourth embodiment will be described with reference to FIG. 8.

An FMCW signal generation circuit 400 according to this embodiment is different from the FMCW signal generation circuit 200 according to the second embodiment in that the magnitude and the polarity of the frequency variation rate are changed in a separate manner. That is, whereas in the second embodiment the selector 209 changes both of the magnitude and the polarity of the frequency variation rate, in this embodiment a selector 409 changes the magnitude of the frequency variation rate and the integrator 407 changes the polarity of the frequency variation rate.

A first set frequency FCW_max representing a maximum frequency and a second set frequency FCW_min representing a minimum frequency are set in a comparator 408. The comparator 408 compares the magnitudes of an output frequency of a first differentiator 403 and FCW_max or compares the magnitudes of an output frequency of the first differentiator 403 and FCW_min, and outputs a comparison result to the selector 409 and the integrator 407.

The selector 409 selects one of a first set frequency variation rate SCW_rise and the absolute value |SCW_fall| of a second set frequency variation rate SCW_fall according to the comparison result of the comparator 408, and outputs the selected set frequency variation rate to a subtracter 406. Symbol SCW_rise represents a set frequency variation rate corresponding to a case that the frequency increases, and has a positive value. And |SCW_fall| represents a set frequency variation rate corresponding to a case that the frequency decreases. The second set frequency variation rate SCW_fall has a negative value.

A second differentiator 404 outputs the absolute value of a frequency variation rate as a parameter representing the magnitude of the frequency variation rate.

The subtractor 406 calculates an error by subtracting the absolute value of the frequency variation rate from the output (SCW_rise or |SCW_fall|) of the selector 409, and outputs the calculated error to the integrator 407.

The integrator 407 generates a control signal by integrating the error additively or subtractively according to the comparison result of the comparator 408. The variation rate of the frequency of the FMCW signal that is output from the oscillator 401 which is controlled by the control signal also varies in polarity. When the integrator 407 integrates the error additively, the polarity of the variation rate of the oscillation frequency is positive. On the other hand, when the integrator 407 integrates the error subtractively, the polarity of the variation rate of the oscillation frequency is negative. The term “to integrate the error additively” means to integrate the errors as it is. The term “to integrate the error subtractively” means to integrate the error multiplied by “−1.”

Next, an operation procedure of the FMCW signal generation circuit 400 according to the embodiment will be described.

First, assume that the selector 409 is selecting the set frequency variation rate SCW_rise and outputting it to the subtractor 406. In this case, the integrator 407 additively integrates the error calculated by the subtractor 406. The oscillator 401 operates so that the frequency variation rate of the FMCW signal coincides with SCW_rise. Therefore, the oscillation frequency increases linearly with time. The selector 409 continues to select SCW_rise and the integrator 407 continues to integrate the error additively as long as the oscillation frequency is lower than FCW_max. On the other hand, if the oscillation frequency becomes higher than FCW_max, the comparator 408 switches the comparison result and the selector 409 selects |SCW_fall| and outputs it to the subtractor 406. The integrator 407 subtractively integrates the error calculated by the subtractor 406 according to the comparison result. The oscillation frequency decreases linearly with time. The selector 209 continues to select |SCW_fall| and the integrator 407 continues to integrate the error subtractively as long as the oscillation frequency is higher than FCW_min. If the oscillation frequency becomes lower than FCW_min, the comparator 408 switches the comparison result and the selector 209 again selects SCW_rise and outputs it to the subtractor 406. The integrator 407 additively integrates the error calculated by the subtractor 406.

As a result of the above operation, an FMCW signal whose frequency varies in a triangular-wave form can be obtained.

The comparator 408 and the selector 409 of the operation procedure of the FMCW signal generation circuit 400 according to the embodiment can both be implemented as a simple circuit.

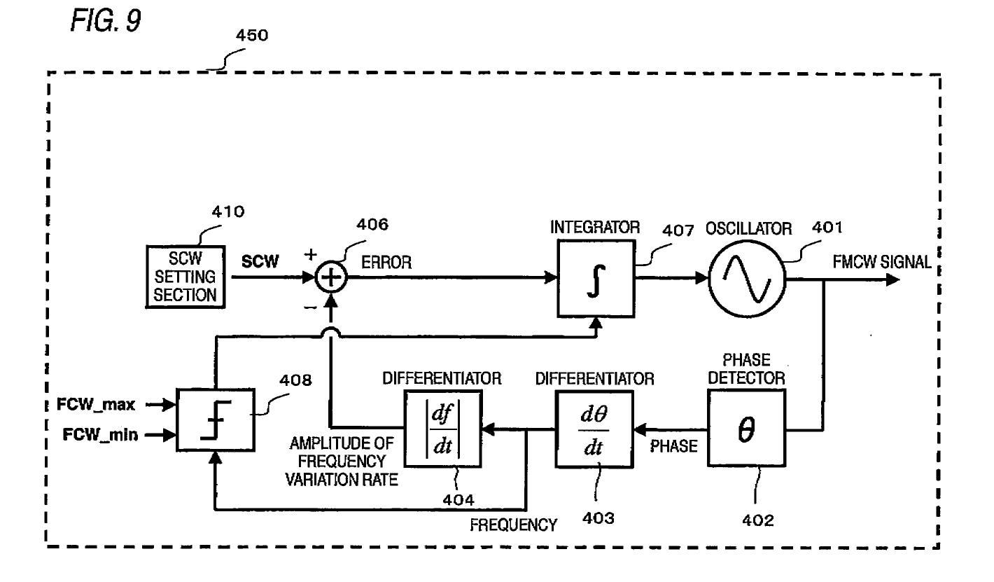

FIG. 9 shows an FMCW signal generation circuit 450 according to a modification of the fourth embodiment, in which SCW_rise is the same as the absolute value |SCW_fall| of SCW_fall. In this case, the frequency of an FMCW signal varies like a triangular wave whose rising slope and falling slope are the same. In this case, the set frequency variation rate can be fixed to SCW. Therefore, in the modification, the selector 409 of the FMCW signal generation circuit 400 according to the fourth embodiment can be replaced by an SCW setting section 410. As a result, the configuration of the FMCW signal generation circuit 450 is made simpler.

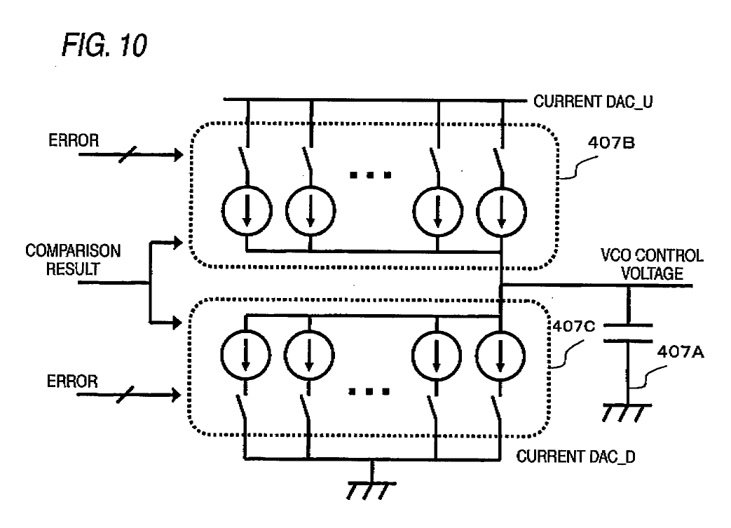

FIG. 10 shows the configuration of the integrator 407 of the FMCW signal generation circuit 400 of FIG. 8. The integrator 407 is composed of a fixed capacitor 407A, a first current DAC 407B (DAC_U) for causing a current to flow into the fixed capacitor 407A, and a second current DAC 407C (DAC_D) for causing a current to flow out of the fixed capacitor 407A. The output current of each of the first current DAC 407B and the second current DAC 407C varies according to the magnitude of the error that is output from the subtractor 406. The integrator 407 performs a selection as to which of the current DACs 4073 and 407C to operate, according to the comparison result of the comparator 408. The integrator 407 causes the first current DAC 407B to operate if the comparison result indicates that the integrator 407 should perform additive integration. The integrator 407 causes the second current DAC 407C to operate if the comparison result indicates that the integrator 407 should perform subtractive integration.

The FMCW signal generation circuit 400 according to the fourth embodiment provides the same advantages as the FMCW signal generation circuit 100 according to the first embodiment does and, in addition, can generate an FMCW signal whose frequency varies in a triangular-wave form with a high degree of linearity. Furthermore, the FMCW signal generation circuit 400 according to the fourth embodiment can be implemented so as to be small in circuit scale and low in power consumption.

### Fifth Embodiment

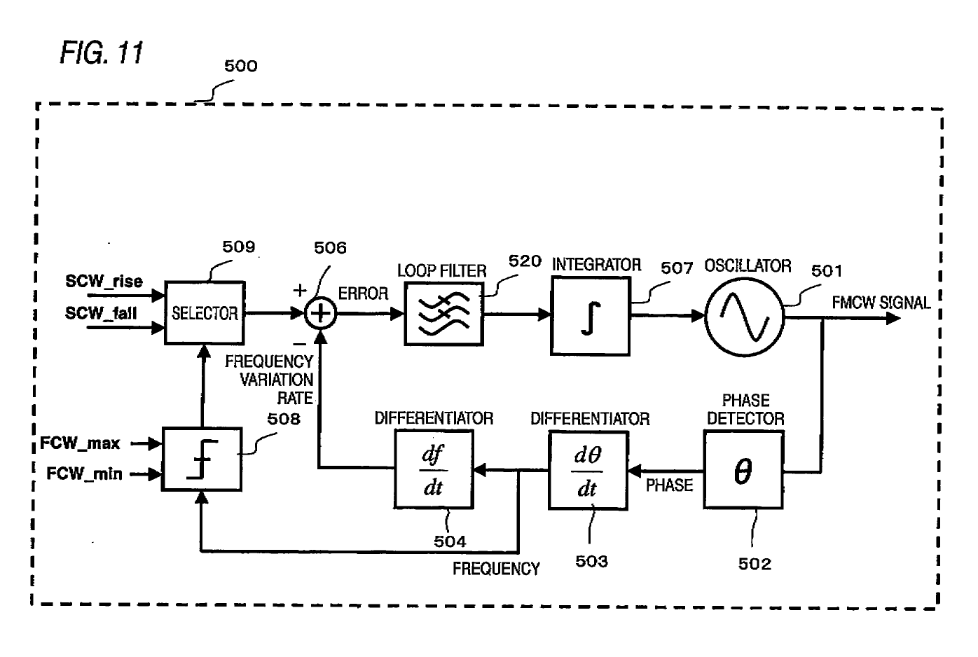

Next, a fifth embodiment will be described with reference to FIG. 11.

An FMCW signal generation circuit 500 according to this embodiment is different from the FMCW signal generation circuit 200 according to the second embodiment in that a loop filter 520 for attenuating high-frequency components is inserted downstream of the subtractor 506. The loop filter 520 has the following three effects.

The first effect of the loop filter 520 is that it renders the negative feedback loop stable. Phase delay occurs in the individual blocks which are electric circuits, and larger phase delays occur for higher frequency components. The negative feedback loop becomes unstable if the gain at a frequency with a phase delay of 180 degrees is larger than 1. The negative feedback loop is allowed to operate stably by reducing gains for high-frequency components with the loop filter 520.

The second effect of the loop filter 520 is that it lowers noise. Noise occurs in the individual blocks of the FMCW signal generation circuit 500 because they are electric circuits. If the loop filter 520 is not inserted, such noise appears as it is in an output FMCW signal. Since the loop filter 520 is inserted downstream of the subtractor 506, noise that occurs in each of the blocks located between the output and the loop filter 520 (i.e., phase detector 502, first differentiator 503, second differentiator 504, and subtractor 506) is subjected to lowpass filtering. On the other hand, noise that occurs in each of the blocks located between the loop filter 520 and the output (i.e., integrator 507 and oscillator 501) is subjected to highpass filtering. As a result, the noise appearing in the output FMCW signal can be reduced.

The third effect of the loop filter 520 is that it eliminates an offset. As described above, the frequency variation rate of an FMCW signal is calculated by the following equation (4).

L[d²φ_{FMCW}/dt²]=K_{VCO/}1+K_{PD}K_{VCO}SCW=SCW/1K_{VCO}+K_{PD} (4)

Since the gain K_{VCO} of the oscillator 501 is finite, the term 1/K_{VCO} is a cause of an offset. Now assume that an integrator which serves as the loop filter 520 is inserted downstream of the subtractor 506. Since the transfer function of the integrator is 1/s, the frequency variation rate of an FMCW signal is given by the following equation (5).

L[d²φ_{FMCW}/dt²]=K_{VCO}/s/1+K_{PD}K_{VCO}/s SCW=SCW/s/K_{VCO}+K_{PD} (5)

The equation (5) shows that the offset term is equal to 0 for a DC component (s=0)

As described above, the fifth embodiment makes it possible to render the negative feedback loop stable, to lower noise, and to eliminate an offset. Furthermore, the fifth embodiment provides the same advantages as the second embodiment does.

### Sixth Embodiment

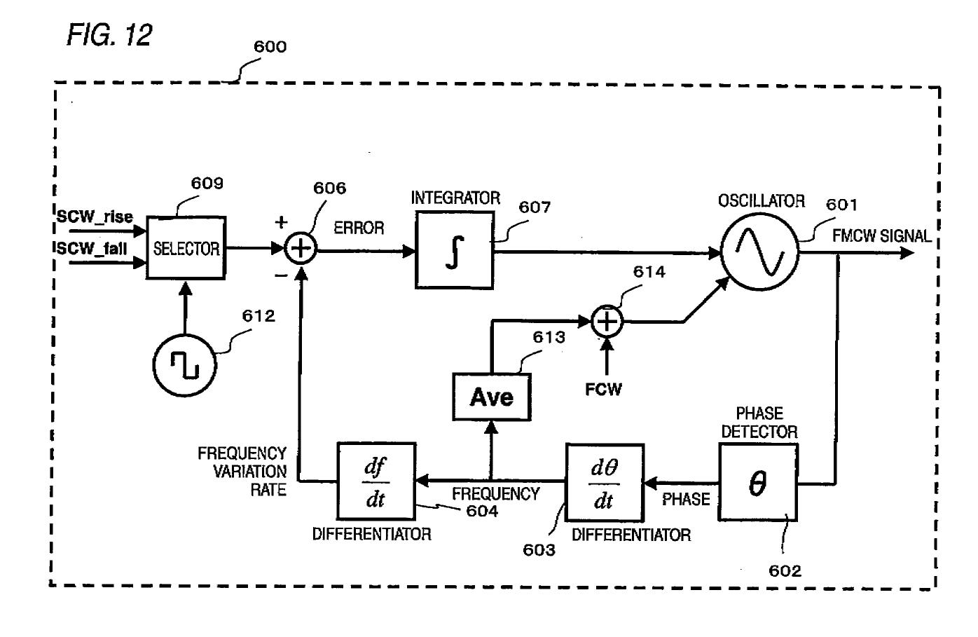

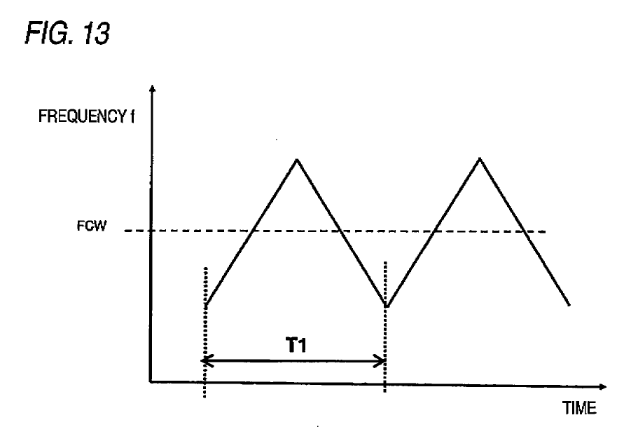

Next, a sixth embodiment will be described with reference to FIGS. 12 and 13. FIG. 12 is a block diagram of an FMCW signal generation circuit 600 according to the sixth embodiment. FIG. 13 shows an FMCW signal that is generated by the FMCW signal generation circuit 600. The FMCW signal generation circuit 600 according to this embodiment is different from the FMCW signal generation circuit 100 according to the first embodiment in that a selector 609, a pulse signal generation circuit 612, an averaging circuit 613, and a second subtractor 614 are added.

An oscillator 601 of the FMCW signal generation circuit 600 according to the embodiment is controlled by a first control signal that is supplied from the integrator 607 and a second control signal that is supplied from the second subtractor 614. As shown in FIG. 13, the oscillator 601 is controlled by the first control signal so that the frequency of an FMCW signal varies in a triangular-wave form. The oscillator 601 is controlled by the second control signal so that the frequency of an FMCW signal varies with a given frequency (set frequency FCW (described later)) as the center frequency (also see FIG. 13).

Where the oscillator 601 is a voltage-controlled oscillator, it has a first input terminal and a second input terminal. Assume that the first control signal (first control voltage V1) and the second control signal (second control voltage V2) are input to the first input terminal and the second input terminal, respectively. In this case, the output signal frequency of the oscillator 601 is given by F0+K_{VCO}1·V1+K_{VCO}2·V2, where K_{VCO}1 and K_{VCO}2 are input-voltage-to-frequency conversion gains for the first input terminal and the second input terminal, respectively, and F0 is an output signal frequency of the oscillator 601 that is obtained when the first control voltage V1 and the second control voltage V2 are 0 V.

Next, a description will be made of how the oscillator 601 is controlled by the first control signal so that its output signal frequency varies in a triangular-wave form.

Receiving pulse signals, the selector 609 controls the SCW which is input to the subtractor 609, whereby the frequency of an FMCW signal is varied in a triangular-wave form.

The pulse signal generation circuit 612 generates pulse signals (first voltage High and second voltage Low) which determine a cycle of the triangular wave. The selector 609 selects SCW_rise (positive value) or SCW_fall (negative value) according to the pulse signal and outputs it to the subtractor 606. The selector 609 selects SCW_rise when the pulse signal is the first voltage High, and selects SCW_fall when the pulse signal is the second voltage Low. When the pulse signal is High, controlled by the first control signal which is output from the integrator 607, the oscillator 601 increases the frequency of the FMCW signal at the variation rate SCW_rise. On the other hand, when the pulse signal is Low, controlled by the first control signal which is output from the integrator 607, the oscillator 601 decreases the frequency of the FMCW signal at the variation rate SCW_fall. Therefore, controlled by the first control signal, the oscillator 601 varies the frequency of the FMCW signal in a triangular-wave form at the same cycle as the cycle of pulse signals.

Next, a description will be made of how the oscillator 601 is controlled by the second control signal so that the frequency of an FMCW signal varies with a given frequency (set frequency FCW (described later)) as the center frequency (see FIG. 13).

The averaging circuit 613 calculates an average value of frequencies that are output from the first differentiator 603. The second subtractor 614 calculates an error between the average frequency and a set frequency FCW and outputs it as the second control signal for the oscillator 601.

An average frequency is determined by using frequencies that are calculated by the first differentiator 603. For example, the averaging circuit 613 calculates an average value of frequencies at a cycle T1 of the FMCW signal (see FIG. 13). The second subtractor 614 calculates a difference between the set frequency FCW and the average frequency calculated by the averaging circuit 613 and inputs the calculated difference to the oscillator 601 as the second control signal. In this manner, the oscillator 601 is controlled so that the average value of frequencies of the signal generated by the oscillator 601 becomes equal to the set frequency FCW. As such, the FMCW signal generation circuit 600 according to the embodiment can generate an FMCW signal whose frequency varies like a triangular wave having, as the center frequency, a frequency determined by the set frequency FCW and having the same cycle as pulse signals (see FIG. 13).

Therefore, the FMCW signal generation circuit 600 can generate an FMCW signal whose frequency varies in a triangular-wave form with a high degree of linearity. Furthermore, the FMCW signal generation circuit 600 can be implemented so as to be small in circuit scale and low in power consumption.

Although in the embodiment an FMCW signal is controlled by using an average value of frequencies, it can be controlled by using a maximum value or a minimum value of frequencies.

### Seventh Embodiment

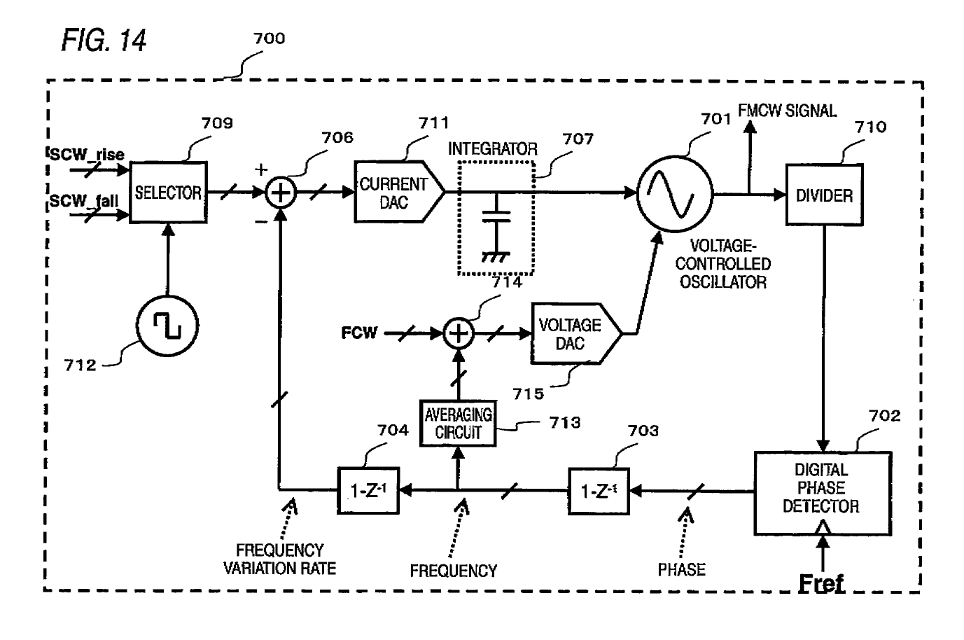

Next, a seventh embodiment will be described with reference to FIG. 14.

An FMCW signal generation circuit 700 according to this embodiment, which is equivalent to the FMCW signal generation circuit 600 according to the sixth embodiment, is configured by using digital circuits and analog circuits. The FMCW signal generation circuit 700 according to this embodiment is different from the FMCW signal generation circuit 300 according to the third embodiment in that a pulse signal generation circuit 712, an averaging circuit 713, a second subtractor 714, and a voltage-output DA converter 715 are added. The FMCW signal generation circuit 700 of this embodiment is not equipped with the comparator 308 that is provided in the FMCW signal generation circuit 300 according to the third embodiment.

The selector 709 selects SCW_fall in response to a pulse signal generated by the pulse signal generation circuit 712. The subtractor 706 calculates a difference between SCW_fall and a frequency variation rate that is output from the second differentiator 704. The current-output analog-to-digital converter 711 outputs a current signal (analog error) that is obtained by analog-converting the calculated error. The fixed capacitor 707 integrates the current signal, and outputs a resulting first control signal to the voltage-controlled oscillator 701 as a first control signal. The averaging circuit 713 averages frequencies that are output from the first differentiator 703. The second subtractor 714 calculates a difference between a set frequency FCW and the average frequency. The voltage-output DA converter 715 analog-converts the frequency error to generate a second control signal for the voltage-controlled oscillator 701.

The second control signal which is output from the voltage-output DA converter 715 is approximately constant with respect to time. Therefore, the voltage-output DA converter 715 may be such as to operate at low speed.

The averaging circuit 713 and the subtractor 706 are implemented as digital circuits.

The FMCW signal generation circuit 700 can generate an FMCW signal whose frequency varies in a triangular-wave form with a high degree of linearity. Furthermore, the FMCW signal generation circuit 700 can be implemented so as to be small in circuit scale and low in power consumption.

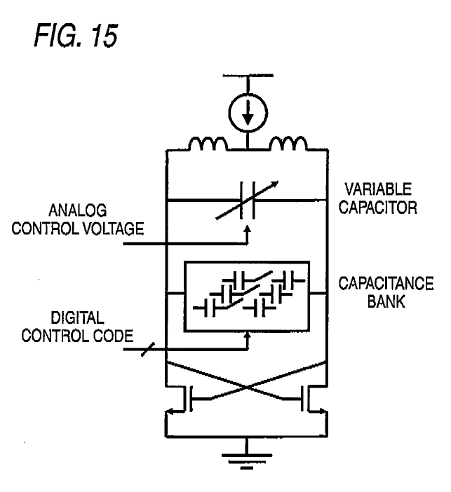

In the FMCW signal generation circuit 700 according to the embodiment, the voltage-output DA converter 715 may be omitted by using a voltage/digital-controlled oscillator as shown in FIG. 15. The voltage/digital-controlled oscillator Controls frequency using an analog control voltage and a digital control code. The analog control voltage is input to the control terminal of a variable capacitor and varies its capacitance continuously. The digital control code is input to a capacitance bank which is a parallel connection of plural fixed capacitors that are connected to respective switches. The switches are controlled by the digital control code, whereby the capacitance of the capacitance bank is varied discretely. The voltage-output DA converter 715 can be omitted by using the output voltage of the integrator 707 as the analog control voltage and using the output of the second subtractor 714 as the digital control code.

In the FMCW signal generation circuit 700, the digital phase detector 702, the current-output analog-to-digital converter 711, and the voltage-output DA converter 715 may operate at different cycles. For example, one of the analog-to-digital converters 711 and 715 may perform oversampling operation, in which case its conversion accuracy is increased. Furthermore, periodic components that may cause spurious emission can be reduced by using a ΣΔ DA Converter.

### Eighth Embodiment

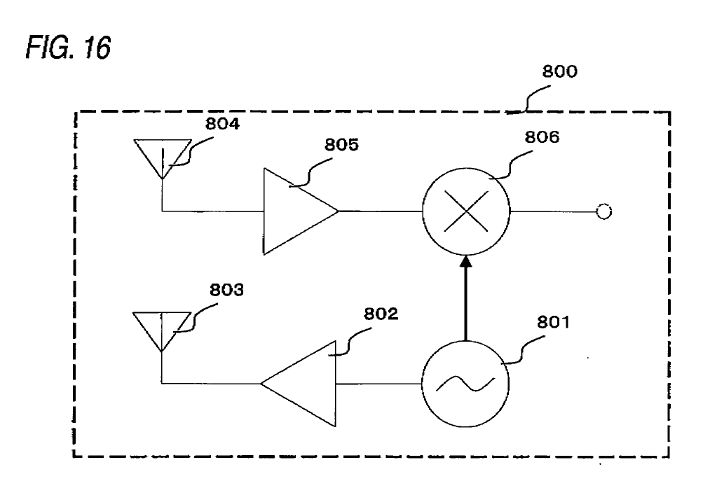

An eighth embodiment will be described below with reference to FIG. 16. A radar apparatus 800 according to this embodiment is characterized by being equipped with an FMCW signal generation circuit 801 which is the FMCW signal generation circuit 100 of FIG. 1, a power amplifier 802 which amplifies an FMCW signal that is output from the FMCW signal generation circuit 801 so that it is given power that is necessary for its transmission, a transmission antenna 803 for sending an amplified signal to the external space, a reception antenna 804 for receiving a return signal because of reflection of the transmitted signal by a target, an amplifier 805 for amplifying the returned signal, and a mixer circuit 806 for producing a sinusoidal signal whose frequency depends on a distance from the target by mixing a reception signal that is output from the amplifier 805 with the output FMCW signal of the FMCW signal generation circuit 801. Instead of using the transmission antenna 803 and the reception antenna 804, the transmission side and the reception side may share a single antenna by using an isolator or the like. If necessary, an amplifier may be added or a filter may be used on each of the transmission side and the reception side. Instead of the FMCW signal generation circuit 100 of FIG. 1, the FMCW signal generation circuit of FIGS. 3, 6, 8, 9, 11, 12, or 14 may be used as the FMCW signal generation circuit 801.

Since the FMCW signal generation circuit 801 is much lower in power consumption than conventional ones, the radar apparatus 800 can be implemented so as to have necessary accuracy though low in power consumption. Furthermore, because of the use of the FMCW signal generation circuit 801 which is low in power consumption and simple in configuration, the radar apparatus 800 can be implemented in the form of a single chip by using a CMOS process or the like.

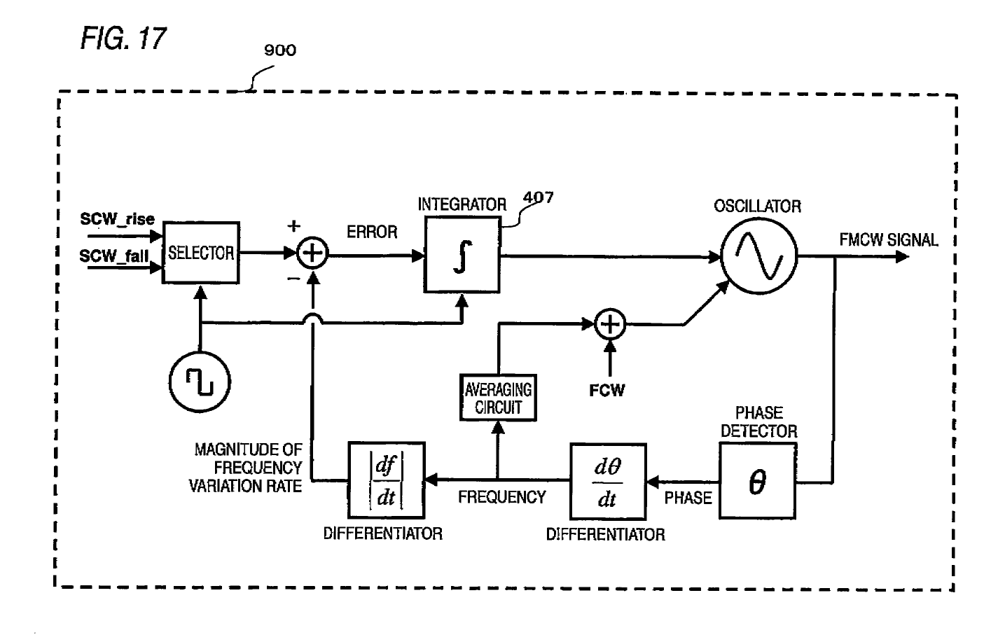

The FMCW signal generation circuit 400 of FIG. 8 may be modified so that an FMCW signal is controlled by pulse signals as in the FMCW signal generation circuit 600 of FIG. 12. A resulting FMCW signal generation circuit 900 is shown in FIG. 17. That is, in the FMCW signal generation circuit 900 of FIG. 17, the absolute value of the frequency variation rate is changed in the cycle of pulse signals and the polarity of the frequency variation rate is switched by the integrator 407.

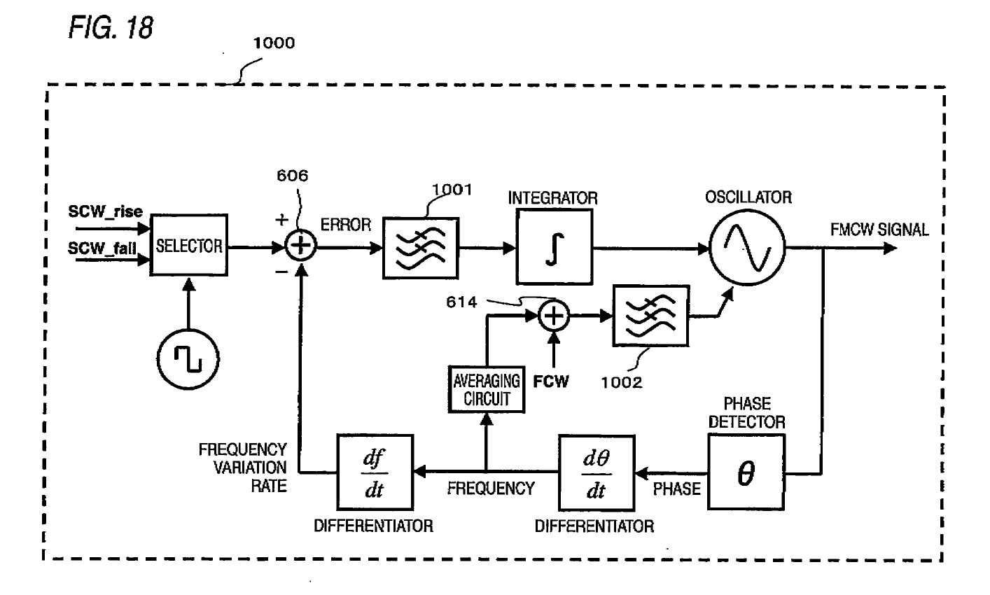

Loop filters may be inserted in the FMCW signal generation circuit 600 of FIG. 12. A resulting FMCW signal generation circuit 1000 is shown in FIG. 18. Inserting a first loop filter 1001 downstream of the subtractor 606 which calculates an error of a frequency variation rate makes it possible to increase the stability of the path for controlling the frequency variation rate, to reduce noise, and to eliminate an offset. Inserting a second loop filter 1002 downstream of the second subtractor 614 which calculates an error of an average value of frequencies makes it possible to increase the stability of the path for controlling the frequency, to reduce noise, and to eliminate an offset.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiments described above. For example, some components may be deleted from the configurations described as the embodiments. Further, the components described in different embodiments may be used appropriately in combination.

What is claimed is:

1. An FMCW signal generation circuit comprising:
an oscillator configured to oscillate in an oscillation frequency that is variable in accordance with a control signal being input thereto and output an FMCW signal having the oscillation frequency;
a phase detector configured to detect a phase of the FMCW signal:
a first differentiator configured to obtain a frequency by differentiating the phase detected by the phase detector;
a second differentiator configured to obtain a frequency variation rate by differentiating the frequency obtained by the first differentiator;
a subtractor configured to calculate an error between a set frequency variation rate that is set at a given value and the frequency variation rate obtained by the second differentiator; and
an integrator configured to generate the control signal for controlling the oscillation frequency of the oscillator by integrating the error calculated by the subtractor.

2. The FMCW signal generation circuit of claim 1 further comprising:
a comparator configured to compare and determine whether the frequency is higher than a first set frequency and whether the frequency is lower than a second set frequency that is lower than the first set frequency; and
a selector configured to select a second set frequency variation rate that is set at a given negative value when the frequency is determined to be higher than the first set frequency and select a first set frequency variation rate that is set at a given positive value when the frequency is lower than the second set frequency,
wherein the subtractor calculates an error between the first set frequency variation rate or the second set frequency variation rate selected by the selector and the frequency variation rate.

3. The FMCW signal generation circuit of claim 1 further comprising:
a comparator configured to compare and determine whether the frequency is higher than a first set frequency and whether the frequency is lower than a second set frequency that is lower than the first set frequency; and
a selector configured to select an absolute value of a second set frequency variation rate that is set at a negative value when the frequency is higher than the first set frequency and select a first set frequency variation rate that is set at a positive value when the frequency is lower than the second set frequency,
wherein the subtractor calculates an error between the first set frequency variation rate or the absolute value of the second set frequency variation rate selected by the selector and an absolute value of the frequency variation rate, and
wherein the integrator integrates the error multiplied by a value of −1 when the frequency is higher than the first set frequency and integrates the error intact when the frequency is lower than the second set frequency.

4. The FMCW signal generation circuit of claim 1 further comprising a comparator configured to compare and determine whether the frequency is higher than a first set frequency and whether the frequency is lower than a second set frequency that is lower than the first set frequency,
wherein the subtractor calculates an error between an absolute value of the set frequency variation rate and the frequency variation rate, and
wherein the integrator integrates the error multiplied by a value of −1 when the frequency is higher than the first set frequency, and integrates the error intact when the frequency is lower than the second set frequency.

5. The FMCW signal generation circuit of claim 1 further comprising:
an averaging circuit configured to calculate an average value of values of the frequency;
a second subtractor configured to generate a second control signal for the oscillator by calculating a difference between a given set frequency and the average value;
a pulse output section configured to output a first voltage and a second voltage periodically; and
a selector configured to select a first set frequency variation rate having a positive value when the pulse output section outputs the first voltage and select a second set frequency variation rate having a negative value when the pulse output section outputs the second voltage,
wherein the subtractor calculates an error that is a difference between the first set frequency variation rate or the second set frequency variation rate selected by the selector and the frequency variation rate,
wherein the integrator generates a first control signal for the oscillator by integrating the error, and
wherein the oscillator generates the FMCW signal by being controlled by the first control signal and the second control signal.

6. An FMCW signal generation circuit comprising:
an oscillator configured to oscillate in an oscillation frequency that is variable in accordance with a control signal being input thereto and output an FMCW signal having the oscillation frequency;
a frequency divider configured to obtain a frequency division signal by frequency-dividing the FMCW signal generated by the oscillator;
a digital phase detector configured to obtain a phase value by detecting a phase of the frequency division signal;
a first differentiator configured to obtain a frequency by differentiating the phase value:
a second differentiator configured to obtain a frequency variation rate by differentiating the frequency obtained by the firs differentiator;
a subtractor configured to calculate a difference between a set frequency variation rate that is set at a given value and the frequency variation rate:
a DA converter configured to convert the difference calculated by the subtractor into an error signal having analog value; and
an integrator configured to generate the control signal for the oscillator by integrating the error signal,
werein the first differentiator, the second differentiator, and the subtractor are configured as digital circuits.

7. The FMCW signal generation circuit of claim 6, wherein the DA converter generates a current by converting the difference,
wherein the integrator has a capacitor configured to store charge corresponding to the current, and
wherein a voltage across the capacitor is output as the control signal.

8. An FMCW signal generation circuit comprising:
an oscillator configured to oscillate in an oscillation frequency that is variable in accordance with a control signal being input thereto and output an FMCW signal having the oscillation frequency;
a frequency divider configured to frequency-divide the FMCW signal generated by the oscillator;
a digital phase detector configured to obtain a phase value by detecting a phase of the FMCW signal being frequency-divided by the frequency divider;
a first differentiator configured to obtain a frequency by differentiating the phase value;
a second differentiator configured to obtain a frequency variation rate by differentiating the frequency;
a comparator configured to compare and determine whether the frequency is higher than a first set frequency and whether the frequency is lower than a second set frequency that is lower than the first set frequency;
a selector configured to select an absolute value of a second set frequency variation rate that is set at a negative value when the frequency is higher than the first set frequency and select a first set frequency variation rate that is set at a given positive value when the frequency is lower than the second set frequency;
a subtractor configured to calculate an error that is a difference between the first set frequency variation rate or the absolute value of the second set frequency variation rate selected by the selector and an absolute value of the frequency variation rate; and
an integrator comprising a fixed capacitor, a first DA converter, and a second DA converter, the integrator being configured to generate the control signal for the oscillator,
wherein the second DA converter causes a current that is proportional to the error to flow out of the fixed capacitor when the frequency is higher than the first set frequency, and
wherein the first DA converter causes a current that is proportional to the error to flow into the fixed capacitor when the frequency is lower than the second set frequency.
